(19) United States
(12) Patent Application Publication
(10) Pub. No.: US 2020/0356592 A1
(43) Pub. Date: Nov. 12, 2020

(54) Plural-Mode Image-Based Search

(71) Applicant: Microsoft Technology Licensing, LLC, Redmond, WA (US)

(72) Inventors: Ravi Theja YADA, Newcastle, WA (US); Houdong HU, Redmond, WA (US); Yan WANG, Mercer Island, WA (US); Saurajit MUKHERJEE, Kirkland, WA (US); Vishal THAKKAR, Kirkland, WA (US); Arun SACHETI, Sammamish, WA (US)

(21) Appl. No.: 16/408,230

(22) Filed: May 9, 2019

(51) Int. Cl. G06F 16/532; G06K 9/00; G06F 17/27; G06K 9/62; G06K 9/72; G06F 16/54; G06F 16/538

(52) U.S. Cl. CPC G06F 16/532; G06K 9/00671; G06F 17/27; G06K 9/6267; G06F 3/167; G06K 9/6201; G06F 16/54; G06F 16/538; G06K 9/726

(57) ABSTRACT

A computer-implemented technique is described herein for generating query results based on both an image and an instance of text submitted by a user. The technique allows a user to more precisely express his or her search intent compared to the case in which a user submits text or an image by itself. This, in turn, enables the user to quickly and efficiently identify relevant search results. In a text-based retrieval path, the technique supplements the text submitted by the user with insight extracted from the input image, and then conducts a text-based search. In an image-based retrieval path, the technique uses insight extracted from the input text to guide the manner in which it processes the input image. In another implementation, the technique generates query results based on an image submitted by the user together with information provided by some other mode of expression besides text.

### BACKGROUND

In present practice, a user typically interacts with a text-based query-processing engine by submitting one or more text-based queries. The text-based query-processing engine responds to this submission by identifying a set of websites containing text that matches the query(ies). Alternatively, in a separate search session, a user may interact with an image-based query-processing engine by submitting a single fully-formed input image as a search query. The image-based query-processing engine responds to this submission by identifying one or more candidate images that match the input image. These technologies, however, are not fully satisfactory. A user may have difficulty expressing his or her search intent in words. For different reasons, a user may have difficulty finding an input image that adequately captures his or her search intent. Image-based searches have other limitations. For example, a traditional image-based query-processing engine does not permit a user to customize an image-based query. Nor does it allow the user to revise a prior image-based query.

### SUMMARY

A computer-implemented technique is described herein for using both text content and image content to retrieve query results. The technique allows a user to more precisely express his or her search intent compared to the case in which a user submits an image or an instance of text by itself. This, in turn, enables the user to quickly and efficiently identify relevant search results.

According to one illustrative aspect, the user submits an input image at the same time as an instance of text. Alternatively, the user submits the input image and text in different respective dialogue turns of a query session.

According to another illustrative aspect, the technique uses a text analysis engine to identify one or more characteristics of the input text, to provide text information. The technique uses an image analysis engine to identify at least one object depicted by the input image, to provide image information. In a text-based retrieval path, the technique combines the text information with the image information to generate a reformulated text query. For instance, the technique performs this task by replacing an ambiguous term in the input text with a term obtained from the image analysis engine, or by appending a term obtained from the image analysis engine to the input text. The technique then submits the reformulated text query to a text-based query-processing engine. In response, the text-based query-processing engine returns the query results to the user.

Alternatively, or in addition, the technique can use insight extracted from the input text to guide the manner in which it processes the input image. For example, in an image-based retrieval path, the image analysis engine can use an image-based retrieval engine to convert the input image into a latent semantic vector, and then use the latent semantic vector in combination with the text information (produced by the text analysis engine) to provide the query results. Those query results correspond to candidate images that resemble the input image and that match attribute information extracted from the text information.

In another implementation, the technique generates query results based on an image submitted by the user together with information provided by some other mode of expression besides text.

The above-summarized technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a timeline that indicates how a user may submit image content and text content (or some other type of content) within a query session.

FIG. 2-4 show three respective examples of user interface presentations that enable the user to perform a plural-mode search operation by submitting an image and an instance of text.

FIG. 5 shows a computing system for performing the plural-mode search operation.

FIG. 6 shows a question-answering (Q&A) engine that can be used in the computing system of FIG. 5.

FIG. 7 shows computing equipment that can be used to implement the computing system of FIG. 5.

FIGS. 8-13 show six respective examples that demonstrate how the computing system of FIG. 5 can perform the plural-mode search operation.

FIG. 14 shows one implementation of a text analysis engine, corresponding to a part of the computing system of FIG. 5.

FIG. 15 shows an image-based retrieval engine, corresponding to another part of the computing system of FIG. 5.

FIGS. 16-18 show three respective implementations of an image classification component, corresponding to another part of the computing system of FIG. 5.

FIG. 19 shows a convolutional neural network (CNN) that can be used to implement different aspects of the computing system of FIG. 5.

FIG. 20 shows a query expansion component, corresponding to another part of the computing system of FIG. 5.

FIGS. 21 and 22 together show a process that represents an overview of one manner of operation of the computing system of FIG. 5.

FIG. 23 shows a process that summarizes an image-based retrieval operation performed by the computing system of FIG. 5.

FIG. 24 shows a process that summarizes a text-based retrieval operation performed by the computing system of FIG. 5.

FIG. 25 shows an illustrative type of computing device that can be used to implement any aspect of the features shown in the foregoing drawings.

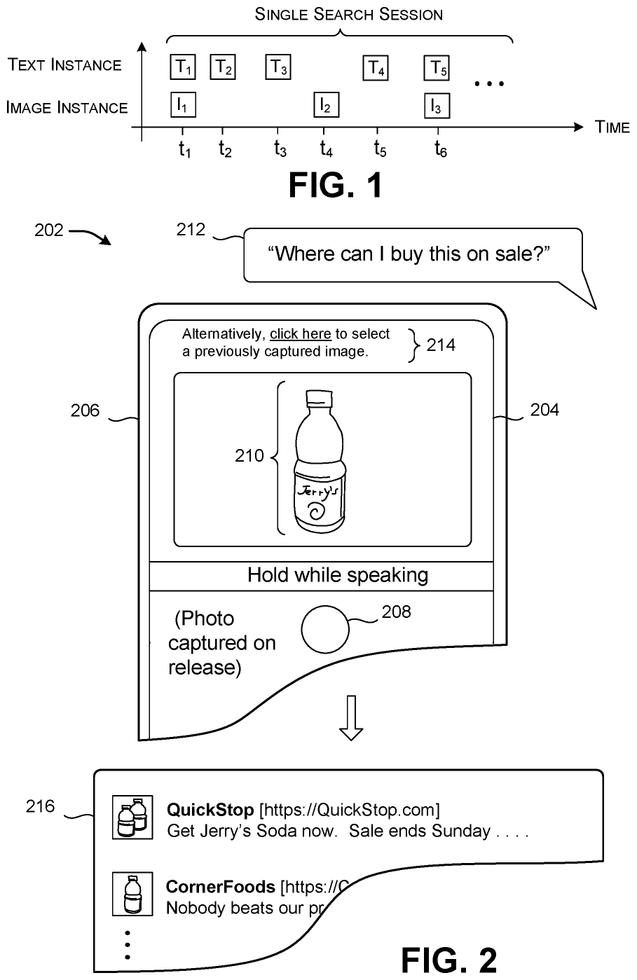

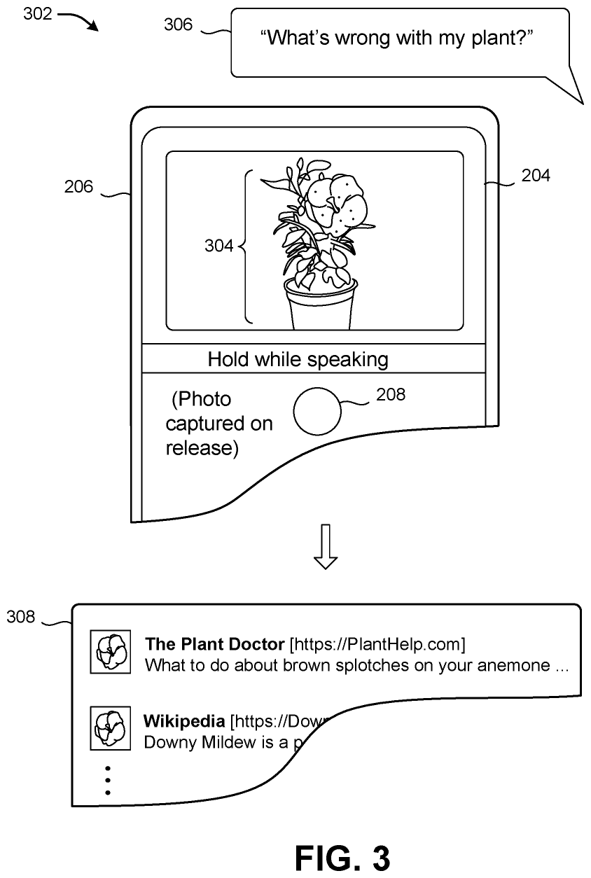

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing system for generating and submitting a plural-mode query to a query-processing engine, and, in response, receiving query results from the query-processing engine. Section B sets forth illustrative methods that explain the operation of the computing system of Section A. And Section C describes illustrative computing functionality that can be used to implement any aspect of the features described in Sections A and B.

As a preliminary matter, the term “hardware logic circuitry” corresponds to one or more hardware processors (e.g., CPUs, GPUs, etc.) that execute machine-readable instructions stored in a memory, and/or one or more other hardware logic units (e.g., FPGAs) that perform operations using a task-specific collection of fixed and/or programmable logic gates. Section C provides additional information regarding one implementation of the hardware logic circuitry. In some contexts, each of the terms “component” and “engine” refers to a part of the hardware logic circuitry that performs a particular function.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic units that include a task-specific collection of logic gates.

As to terminology, the phrase “configured to” encompasses various physical and tangible mechanisms for performing an identified operation. The mechanisms can be configured to perform an operation using the hardware logic circuitry of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical element that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Computing System

FIG. 1 shows a timeline that indicates how a user may submit image content and text content over the course of a single query session. In this merely illustrative case, the timeline shows six instances of time corresponding to six respective turns in the query session. Over the course of these turns, the user attempts to answer a single question. For instance, the user may wish to discover the location at which to purchase a desired product.

More specifically, at time t₁, the user submits an image and an instance of text to a query-processing engine as part of the same turn. At times t₂ and t₃, the user separately submits two respective instances of text, unaccompanied by image content. At time t₄, the user submits another image to the query-processing engine, without any text content. At time t₅, the user submits another instance of text, unaccompanied by any image content. And at time t₆, the user again submits an image and an instance of text as part of the same turn.

The user may provide text content using different input devices. In one case, the user may supply text by typing the text using any type of key input device. In another case, the user may supply text by selecting a phrase in an existing document. In another case, the user may supply text in speech-based form. A speech recognition engine then converts an audio signal captured by a microphone into text. Any subsequent reference to the submission of text is meant to encompass at least the above-identified modes of supplying text. The user may similarly provide image content using different kinds of input devices, described in greater detail below.

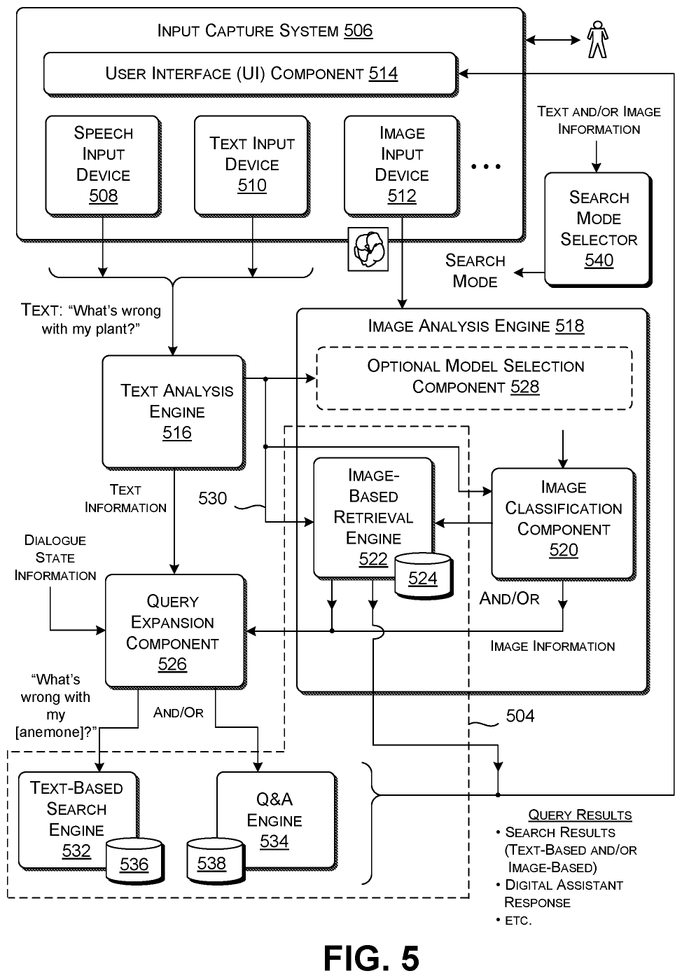

A computing system (described below in connection with FIG. 5) performs a plural-mode search operation to generate query results based on the input items collected at each instance of time. The search operation is referred to as “plural-mode” because it is based on the submission of information using at least two modes of expression, here, an image-based expression and a text-based expression. In some cases, a user may perform a plural-mode search operation by submitting two types of content at the same time (corresponding to time instances t₁ and t₆). In other cases, the user may perform a plural-mode search operation by submitting the two types of content in different turns, but where those separate submissions are devoted to a single search objective. Each such query may be referred to as a plural-mode query because it encompasses two or more modes of expression (e.g., image and text). The example of FIG. 1 differs from conventional practice in which a user conducts a search session by submitting only text queries to a text-based query-processing engine. The example also differs from the case in which a user submits a single image-based query to an image-based query-processing engine.

In other examples, a user may perform a plural-mode search operation by combining input image content with any other form of expression, not limited to text. For example, a user may perform a plural-mode search operation by supplementing an input image with any type of gesture information captured by a gesture recognition component. For instance, gesture information may indicate that the user is pointing to a particular part of the input image; this conveys the user's focus of interest within the image. In another case, a user may perform a plural-mode search operation by supplementing an input image with gaze information captured by a gaze capture mechanism. The gaze information may indicate that the user is focusing on a particular part of the input image. However, to simplify explanation, this disclosure will mostly present examples in which a user performs a plural-mode search operation by combining image content with text context.

FIG. 2 shows a first example 202 of a user interface presentation 204 provided by a computing device 206. The computing device 206 here corresponds to a handheld unit, such as a smartphone, tablet-type computing device, etc. But more generally, the computing device 206 can corresponds to any kind of computing unit, including a computer workstation, a mixed-reality device, a body-worn device, an Internet-of-Things (IoT) device, a game console, etc. Assume that the computing device 206 provides at least one or more digital cameras for capturing image content and one or more microphones for capturing audio content. Further assume that the computing device 206 includes data stores for storing captured image content and audio content, e.g., which it stores as respective image files and audio files.

The user interface presentation 204 allows a user to enter information using two or more forms of expression, on the basis of which the computing system performs a plural-mode search operation. In the example of FIG. 2, the user interface presentation 204 includes a single graphical control element 208. The user presses the graphical control element 208 to begin recording audio content. The user removes his or her finger from the graphical control element 208 to stop recording audio content. A digital camera captures an image when the user first presses the graphical control element 208 or when the user removes his or her finger from the graphical control element 208. At this time, the computing system automatically performs a plural-model search operation based on the input image and the input text.

The above example is merely illustrative. In other cases, the user can interact with the computing system using other kinds of graphical control elements compared to that depicted in FIG. 2. For example, in another case, a graphical user interface presentation can include: a first graphical control element that allows the user to designate the beginning and end of an audio recording; a second graphical control element that allows the user to take a picture of an object-of-interest; and a third control element that informs the computing system that the user is finished submitting content. Alternatively, or in addition, the user can convey recording instructions using physical control buttons (not shown) provided by the computing device 206, and/or by using speech-based commands, and/or by using gesture-based commands, etc.

In the specific example of FIG. 2, the user points the digital camera at a bottle of soda. The user interface presentation 204 includes a viewfinder that shows an image 210 of this object. While pointing the camera at the object, the user utters the query “Where can I buy this on sale?” A speech bubble 212 represents this expression. This expression evinces the user's intent to determine where he or she might purchase the product shown in the image 210. A speech recognition engine (not shown) converts an audio signal captured by a microphone into text.

Although not shown, a user may alternatively input text by using a key input mechanism provided by the computing device 206. Further, the user interface presentation 204 can include a graphical control element 214 that invites the user to select a preexisting image in a corpus of preexisting images, or to select a preexisting image within a web page or other source document or source content item. The user may choose a preexisting image in lieu of, or in addition to, an image captured in real time by the digital camera. In yet another variation (not shown), the user may opt to capture and submit two or more images of an object in a single session turn.

In response to the submitted text content and image content, a query-processing engine returns query results and displays the query results on a user interface presentation 216 provided by an output device. For instance, the computing device 206 may display the query results below the user interface presentation 204. For the illustrative case in which the query-processing engine performs a text-based web search, the query results summarize websites for stores that purport to sell the product illustrated in the image 210. More specifically, in one implementation, the query results include a list of result snippets. Each result snippet can include a text-based and/or an image-based summary of content conveyed by a corresponding website (or other matching document).

FIG. 3 shows a second example 302 in which the user points the camera at a plant while uttering the expression “What's wrong with my plant?” An image 304 shows a representation of the plant at a current point in time, while a speech bubble 306 represents the user's expression. In this case, the user seeks to determine what type of disease or condition is affecting his or her plant. In response to this input information, the query-processing engine presents query results in a user interface presentation 308. For the illustrative case in which the query-processing engine performs a text-based web search, the query results summarize websites that provide advice on conditions that may be negatively affecting the user's plant.

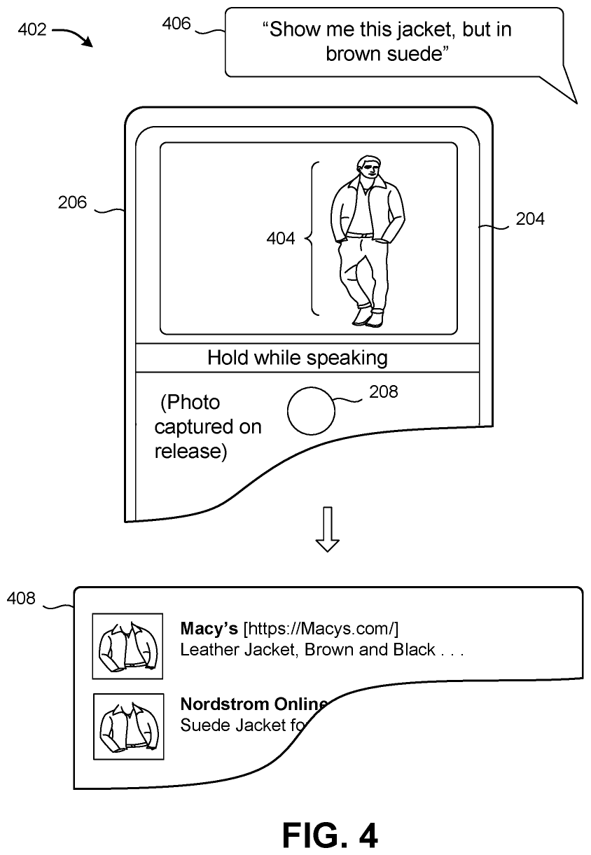

FIG. 4 shows a third example 402 in which the user points the camera at a person while uttering the expression “Show me this jacket, but in brown suede.” An image 404 shows a representation of the person at a current point in time wearing a black leather jacket, while a speech bubble 406 represents the user's expression. Or the image 404 may correspond to a photo that the user has selected on a web page. In either case, the user wants the query-processing engine to recognize the jacket worn by the person and to show similar jackets, but in brown suede rather than black leather. Note that, in this example, the user is interested in a particular part of the image 404, not the image as a whole. For example, the user is not interested in the style of pants worn by the person in the image 404. In response to this input information, the query-processing engine presents query results in a user interface presentation 408. In one scenario, the query results identify websites that describe the desired jacket under consideration.

In the above examples, the query-processing engine corresponds to a text-based search engine that performs a text-based web search to provide the query results. The text-based web search leverages insight extracted from the input image. Alternatively, or in addition, the query-processing engine corresponds to an image-based retrieval engine that retrieves images based on the user's plural-mode input information. More specifically, in an image-based retrieved mode, the computing system uses insight from the text analysis (performed on an instance of input text) to assist an image-based retrieval engine in retrieving appropriate images.

In general, the user can more precisely describe his or her search intent by using plural modes of expression. For example, in the example of FIG. 3, the user may only have a vague understanding that his or her plant has a disease. As such, the user may have difficultly describing the plant's condition in words alone. For example, the user may not appreciate what visual factors are significant in assessing the plant's disease. The user confronts a different limitation when he or she attempts to learn more about the plant by submitting an image of the plant, unaccompanied by text. For instance, based on the image alone, the query-processing engine will likely inform the user of the name of the plant, not its disease. The computing system described herein overcomes these challenges by using the submitted text to inform the interpretation of the submitted image, and/or by using the submitted image to inform the interpretation of the submitted text.

One technical merit of the above-described solution is that it allows a user to more efficiently convey his or her search intent to the query-processing engine. For example, in some cases, the computing system allows the user to obtain useful query results in fewer session turns, compared to the case of conducting a pure text-based search or a pure image-based search. This advantage offers good user experience and makes more efficient use of system resources (insofar as the length of a search session has a bearing on an amount of processing, storage, and communication resources that will be consumed by the computing system in providing the query session).

FIG. 5 shows a computing system 502 for submitting a plural-mode query to a query-processing engine 504, and, in response, receiving query results from the query-processing engine 504. The computing system 502 will be described below in generally top-to-bottom fashion.

As summarized above, the query-processing engine 504 can encompass different mechanisms for retrieving query results. In a text-based path, the query-processing engine 504 uses a text-based search engine and/or a text-based question-answering (Q&A) engine to provide the query results. In an image-based path, the query-processing engine 504 uses an image-based retrieval engine to provide the query results. In this case, the image results include images that the image-based retrieval engine deems similar to an input image.

An input capture system 506 provides a mechanism by which a user may provide input information for use in performing a plural-mode search operation. The input capture system 506 incudes plural input devices, including, but not limited to, a speech input device 508, a text input device 510, an image input device 512, etc. The speech input device 508 corresponds to one or more microphones in conjunction with a speech recognition component. The speech recognition component can use any machine-learned model to convert an audio signal provided by the microphone(s) into text. For instance, the speech recognition component can use a recurrent neural network (RNN) that is composed of long short-term memory (LSTM) units, a hidden Markov model (HMI), etc. The text input device 510 can correspond to a key input device with physical keys, a “soft” keyboard on a touch-sensitive display device, etc. The image input device 512 can correspond to one more digital cameras for capturing still images, one or more video cameras, one or more depth camera devices, etc.

Although not shown, the input devices can also include mechanisms for inputting information in a form other than text or image. For example, another input device can correspond to a gesture-recognition component that determines when the user has performed a hand or body movement indicative of a telltale gesture. The gesture-recognition component can receive image information from the image input device 512. It can then use any pattern-matching algorithm or machine-learned model(s) to detect telltale gestures based on the image information. For example, the gesture-recognition component can use an RNN to perform this task. Another input device can correspond to a gaze capture mechanism. The gaze capture mechanism may operate by projecting light onto the user's eyes and capturing the glints reflected from the user's eyes. The gaze capture mechanism can determine the directionality of the user's gaze based on detected glints.

However, to simplify the explanation, assume that a user interacts with the input capture system 506 to capture an instance of text and a single image. Further assume that the user enters these two input items in a single turn of a query session. But as pointed out with respect to FIG. 1, the user can alternatively enter these two input items in different turns of the same session.

The input capture system 506 can also include a user interface (UI) component 514 that provides one or more user interface (UI) presentations through which the user may interact with the above-described input devices. For example, the UI component 514 can provide the kinds of UI presentations shown in FIGS. 2-4 that assist the user in entering a dual-mode query. In addition, the UI component 514 can present the query results provided by the query-processing engine 504. The user may also interact with the UI component 514 to select a content item that has already been created and stored. For instance, the user may interact with the UI component 514 to select an image within a collection of images, or to pick an image from a web page, etc.

A text analysis engine 516 performs analysis on the input text provided by the input capture system 506, to provide text information. An image analysis engine 518 performs analysis on the input image provided by the input capture system 506, to provide image information. FIGS. 13-18 provide details regarding various ways of implementing these two engines (516, 518). By way of overview, the text analysis engine 516 can perform various kinds of syntactical and semantic analyses on the input text. The image analysis engine 518 can identify one or more objects contained in the input image.

More specifically, in one implementation, the image analysis engine 518 can use an image classification component 520 to classify the object(s) in the input image with respect to a set of pre-established object categories. It performs this task using one or more machine-trained classification models. Alternatively, or in addition, an image-based retrieval engine 522 can first use an image encoder component to convert the input image into at least one latent semantic vector, referred to below as a query semantic vector. The image-based retrieval engine 522 then uses the query semantic vector to find on more candidate images that match the input image. More specifically, the image-based retrieval engine 522 can consult an index provided in a data store 524 that provides candidate semantic vectors associated with respective candidate images. The image-based retrieval engine 522 finds those candidate semantic vectors that are closest to the query semantic vector, as measured by any vector-space distance metric (e.g., cosine similarity). Those nearby candidate semantic vectors are associated with matching candidate images.

The text information provided by the text analysis engine 516 can include the original text submitted by the user together with analysis results generated by the text analysis engine 516. The text analysis results can include domain information, intent information, slot information, part-of-speech information, parse-tree information, one or more text-based semantic vectors, etc. The image information supplied by the image analysis engine 518 can include the original image content together with object information generated by the image analysis engine 518. The object information generally describes the objects present in the image. For each object, the object information can specifically include: (1) a classification label and/or any other classification information provided by the image classification component 520; (2) bounding box information provided by the image classification component 520 that specifies the location of the object in the input image; (3) any textual information provided by the image-based retrieval engine 522 (that it extracts from the index in the data store 524 upon identifying matching candidate images); (4) an image-based semantic vector for the object (that is produced by the image-based retrieval engine 522), etc. In addition, the image analysis engine 518 can include an optical character recognition (OCR) component (not shown). The image information can include textual information extracted by the OCR component.

Although not shown, the computing system 502 can incorporate additional analysis engines in the case in which the user supplies an input expression in a form other than text or image. For example, the computing system 502 can include a gesture analysis engine for providing gesture information based on analysis of a gesture performed by the user.

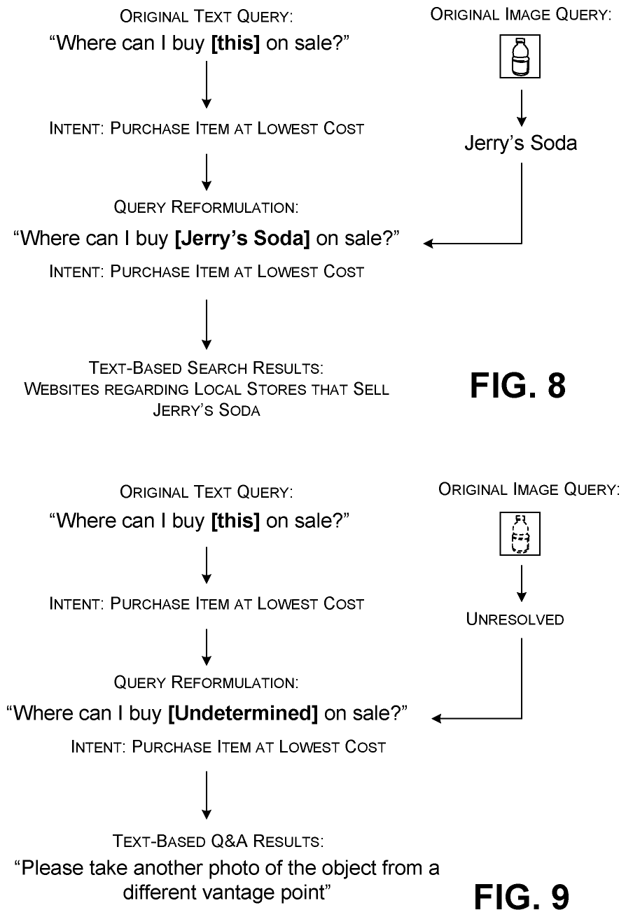

The computing system 502 can provide query results using either a text-based retrieval path or an image-based retrieval path. In the text-based retrieval path, a query expansion component 526 generates a reformulated text query by using the image information generated by the image analysis engine 518 to supplement the text information provided by the text analysis engine 516. The query expansion component 526 can perform this task in different ways, several of which are described below in connection with FIGS. 8-13. To give a preview of one example, the query expansion component 526 can replace a pronoun or other ambiguous term in the input text with a label provided by the image analysis engine 518. For example, assume that a user take a photograph of the Roman Coliseum while asking, “When was this thing built?” The image analysis engine 518 will identify the image as a picture of the Roman Coliseum, and provide a corresponding label “Roman Coliseum.” Based on this insight, the query expansion component 526 can modify the input text to read, “When was [the Roman Coliseum] built?”

In the above example, the information produced by the image analysis engine 518 supplements the text information provided by the text analysis engine 516. In addition, or alternatively, the work performed by the image analysis engine 518 can benefit from the analysis performed by the text analysis engine 516. For example, consider the scenario of FIG. 2 in which the user's speech query asks about a disease that may afflict a plant. An optional model selection component 528 can map information provided by the text analysis engine 516 into an identifier of a classification model to be applied to the user's input image. The model selection component 528 can then instruct the image classification component 520 to apply the selected model. For example, the model selection component 528 can instruct the image classification component 520 to apply a model that has been specifically trained to recognize plant diseases.

Alternatively, or in addition, the image classification component 520 and/or the image-based retrieval engine 522 can directly leverage text information produced by the text analysis engine 516. Path 530 conveys this possible influence. For example, the image classification component 520 can use a text-based semantic vector as an additional feature (along with image-based features) in classifying the input image. The image-based retrieval engine 522 can use a text-based semantic vector (along with an image-based semantic vector) to find matching candidate images.

After generating the reformulated text query, the computing system 502 submits it to the query-processing engine 504. In one implementation, the query-processing engine 504 corresponds to a text-based search engine 532. In other cases, the query-processing engine 504 corresponds to a text-based question-answering (Q&A) engine 534. In either case, the query-processing engine 504 provides query results to the user in response to the submitted plural-mode query.

The text-based search engine 532 can use any search algorithm to identify candidate documents (such as websites) that match the reformulated query. For example, the text-based search engine 532 can compute a query semantic vector based on the reformulated query, and then use the query semantic vector to find matching candidate documents. It performs this task by finding nearby candidate semantic vectors in an index (in a data store 536). The text-based search engine 532 can assess the relation between two semantic vectors using any distance metric, such as Euclidean distance, cosine similarity, etc. In other words, in one implementation, the text-based search engine 532 can find matching candidate documents in the same manner that the image-based retrieval engine 522 finds matching candidate images.

In one implementation, the Q&A engine 534 can provide a corpus of pre-generated questions and associated answers in a data store 538. The Q&A engine 534 can find the question in the data store that most closely matches the submitted the reformulated query. For instance, the Q&A engine 534 can perform this task using the same technique as the search engine 532. The Q&A engine 534 can then deliver the pre-generated answer that is associated with the best-matching query.

In the image-based retrieval path, the computing system 502 relies on the image analysis engine 518 itself to generate the query results. In other words, in the text-based retrieval path, the image analysis engine 518 serves a support role by generating image information that assists the query expansion component 526 in reformulating the user's input text. But in the image-based retrieval path, the image-based retrieval engine 522 and/or the image classification component 520 provide an output result that represents the final outcome of the plural-mode search operation. That output result may include a set of candidate images provided by the image-based retrieval engine 522 that are deemed similar to the user's input image, and which also match aspects of the user's input text. Alternatively, or in addition, the output result may include classification information provided by the image classification component 520.

The operation of the image-based retrieval engine 522 in connection with the image-based retrieval path will be clarified below in conjunction with the explanation of FIG. 15. By way of overview, the image-based retrieval engine 522 can extract attribute information from the text information (generated by the text analysis engine 516). The image-based retrieval engine 522 can then use the latent semantic vector(s) associated with the input image in combination with the attribute information to retrieve relevant images.

In yet another mode, the computing system 502 can generate query results by performing both a text-based search operation and an image-based search operation. In this case, the query results can combine information extracted from the text-based search engine 532 and the image-based retrieval engine 522.

An optional search mode selector 540 determines what search mode should be invoked when the user submits a plural-mode query. That is, the search mode selector 540 determines whether the text-based search path should be used, or the image-based search path, or both the text-based and image-based search paths. The search mode selector 540 can make this decision based on the text information (provided by the text analysis engine 516) and/or the image information (provided by the image analysis engine 518). In one implementation, for instance, the text analysis engine 516 can include an intent determination component that classifies the intent of the user's plural-mode query based on the input text. The search mode selector 540 can choose the image-based search path when the user's input text indicates that he or she wishes to retrieve images that have some relation to the input image (as when the user inputs the text, “Show me this dress, but in blue”). The search mode selector 540 can choose the text-based search path when the user's input indicates that the user has a question about an object depicted in an image (as when the user inputs the text, “Can I put this dress in the washer?”).

In one implementation, the search mode selector 540 performs its function using a set of discrete rules, which can be formulated as a lookup table. For example, the search mode selector 540 can invoke the text-based retrieval path when the user's input text includes a key phrase indicative of his or her attempt to discover where he can buy a product depicted in an image (such as the phrase “Where can I get this,” etc.). The search mode selector 540 can invoke the image-based retrieval path when the user's input text includes a key phrase indicative of the user's desire to retrieve images (such as the phrase “Show me similar items,” etc.). In another example, the search mode selector 540 generates a decision using a machine-trained model of any type, such as a convolutional neural network (CNN) that operates based on an n-gram representation of the user's input text.

In other cases, the search mode selector 540 can take the image information generated by the image analysis engine 518 into account when deciding what mode to invoke. For example, users may commonly apply an image-based search mode for certain kinds of objects (such as clothing items), and a text-based search mode for other kinds of objects (such as storefronts). The search mode selector 540 can therefore apply knowledge about the kind of objects in the input image (which it gleans from the image analysis engine 518) in deciding the likely intent of the user.

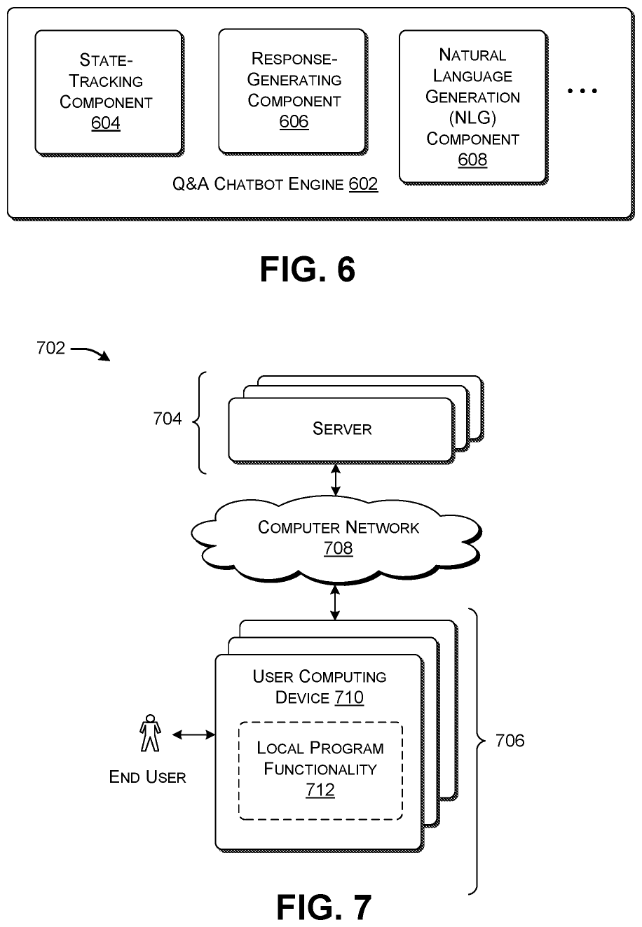

FIG. 6 shows another implementation of a text-based Q&A engine 602 that uses a chatbot interface to interact with the user. That Q&A engine 602 can include a state-tracking component 604, a response-generating component 606, and a natural language generation (NLG) component 608. The state-tracking component 604 monitors the user's progress towards completion of a task based on the user's prior submission of plural-mode queries. For example, assume that an intent determination component determines that a user is attempting to perform a particular task that requires supplying a set of information items to the Q&A engine 602. The state-tracking component 604 keeps track of which of these information items have been supplied by the user, and which information items have yet to be supplied. The state-tracking component 604 also logs the plural-mode queries submitted by the user themselves for subsequent reference.

The response-generating component 606 provides environment-specific logic for mapping the user's reformulated text query into a response. In the example of FIG. 5, the response-generating component 606 performs this task by mapping the reformulated text query into a best-matching existing query in the data store 538. It then supplies the answer associated with that best-matching query to the user. In another case, the response-generating component 606 uses one or more predetermined dialogue scripts to generate a response. In another case, the response-generating component 606 uses one or more machine-generated models to generate a response. For example, the response-generating component 606 can map a reformulated text query into output information using a generative model, such as an RNN composed of LSTM units.

The NLG component 608 maps the output of the response-generating component 606 into output text. For example, the response-generating component 606 can provide output information in parametric form. The NLG component 608 can map this output information into human-understandable output text using a lookup table, a machine-trained model, etc.

FIG. 7 shows computing equipment 702 that can be used to implement the computing system 502 of FIG. 5. The computing equipment 702 includes one or more servers 704 coupled to one or more user computing devices 706 via a computer network 708. The user computing devices 706 can correspond to any of: desktop computing devices, laptop computing devices, handheld computing devices of any types (smartphones, tablet-type computing devices, etc.), mixed reality devices, game consoles, wearable computing devices, intelligent Internet-of-Thing (IoT) devices, and so on. Each user computing device (such as representative user computing device 710) includes local program functionality (such as representative local program functionality 712). The computer network 708 may correspond to a wide area network (e.g., the Internet), a local area network, one or more point-to-point links, etc., or any combination thereof.

The functionality of the computing system 502 can be distributed between the servers 704 and the user computing devices 706 in any manner. In one implementation, the servers 704 implement all functions of the computing system 502 of FIG. 5 except the input capture system 506. In another implementation, each user computing device implements all of the functions of the computing system 502 of FIG. 5 in local fashion. In another implementation, each user computing device implements some analysis tasks, while the servers 704 implement other analysis tasks. For example, each user computing device can implement at least some aspects of the text analysis engine 516, but the computing system 502 delegates more data-intensive processing performed by the text analysis engine 516 and the image analysis engine 518 to the servers 704. Likewise, the servers 704 can implement the query-processing engine 504.

FIGS. 8-13 show five examples that demonstrate how the computing system 502 of FIG. 5 can perform a plural-mode search operation. Starting with the example of FIG. 8, the user submits text that reads “Where can I buy this on sale?” together with an image of a bottle of a soft drink. The text analysis engine 516 determines that the intent of the user is to purchase the product depicted in the image at the lowest cost. The image analysis engine 518 determines that the image shows a picture of a particular brand of soft drink. In response to these determinations, the query expansion component 526 replaces the word “this” in the input text with the brand name of the soft drink identified by the image analysis engine 518.

In the case of FIG. 9, the user inputs the same information as the case of FIG. 8. In this example, however, the image analysis engine 518 cannot ascertain the object depicted in the image with sufficient confidence (as assessed using an environment-specific confidence threshold). This, in turn, prevents the query expansion component 526 from meaningfully supplementing the input text. In one implementation, the Q&A engine 602 (of FIG. 6) responds to this scenario by issuing a response, “Please take another photo of the object from a different vantage point.” The Q&A engine 602 can invoke this kind of response whenever the image analysis engine 518 is unsuccessful in interpreting an input image. In addition, or alternatively, the Q&A engine 602 can invite the user to elaborate on his or her search objectives in text-based form. The Q&A engine 602 can invoke this kind of response whenever the text analysis engine 516 cannot determine the user's search objective as it relates to the input image. This might be the case even though the image analysis engine 518 has successfully recognized objects in the image. The Q&A engine 534 can implement above-described kinds of decisions using discrete rules and/or a machine-trained model.

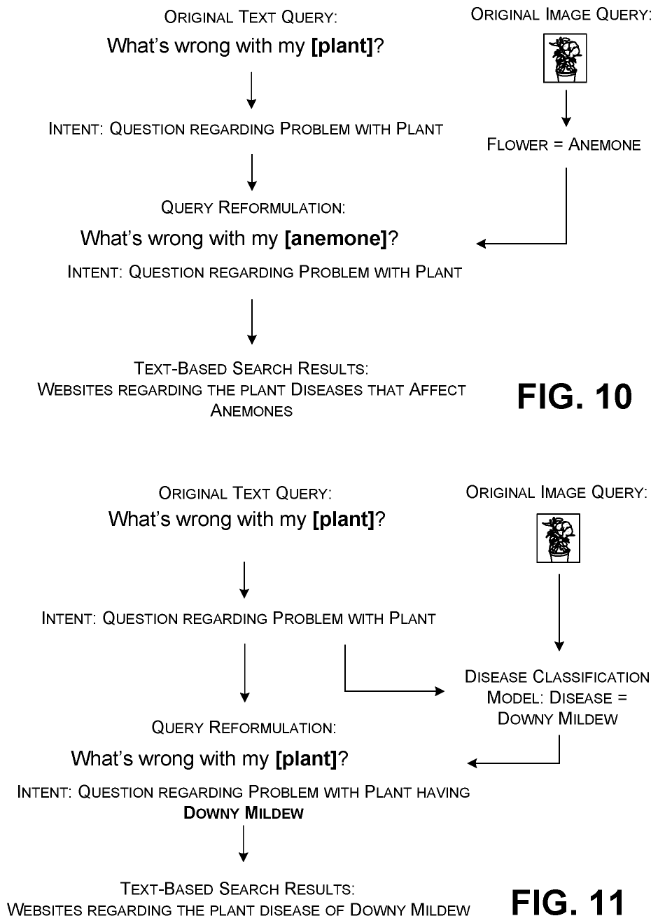

In FIG. 10, the user submits text that reads “What's wrong with my plant?” together with a picture of a plant. The text analysis engine 516 determines that the intent of the user is to find information regarding a problem that he or she is experiencing with a plant. The image analysis engine 518 determines that the image shows a picture of a particular kind of plant, an anemone. In response, the query expansion component 526 replaces the word “plant” in the input text with “anemone,” or supplements the input text with the word “anemone.” Based on this reformulated query, the search engine 532 will retrieve query results for the plant “anemone.” In addition, the search engine 532 will filter the search results for anemones to emphasize those that have a bearing on plant diseases, e.g., by promoting those websites that contain the words “disease,” “health,” “blight,” etc. This is because the user's input text relates to issues of plant health.

In the case of FIG. 11, the user supplies the same information as in the case of FIG. 9. In this example, however, the image analysis engine 518 uses intent information provided by the text analysis component 516 to determine that the user is asking a question about a plant condition. In response, the model selection component 528 invokes a machine-trained classification model that is specifically trained to recognize plant diseases. The image classification component 520 uses this classification model to determine that the input image depicts the plant disease of “downy mildew.” The query expansion component 526 leverages this insight by appending the term “downy mildew” to the originally-submitted text, e.g., as supplemental metadata. In another example, the image classification component 520 can use a first classification model to recognize the type of plant shown in the image, and a second classification model to recognize the plant's condition. This will allow the query expansion component 526 to include both terms “downy mildew” and “anemone” in its reformulated query.

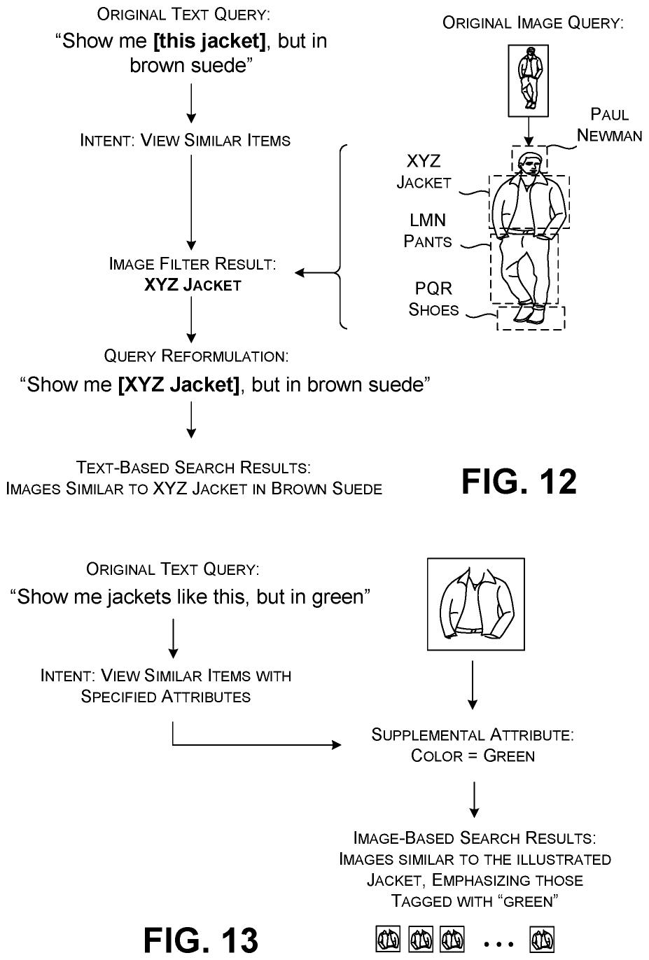

In FIG. 12, the user submits text that reads “Show me this jacket, but in brown suede” together with an image that shows a human model wearing a black leather jacket. The text analysis engine 516 determines that the intent of the user is to find information regarding a jacket that is similar to the one shown in the image, but in a different material than the jacket shown in the image. The image analysis engine 518 uses image segmentation and object detection to determine that the image shows a picture of a model wearing a particular brand of jacket, a particular brand of pants, and a particular brand of shoes. The image analysis engine 518 can also optionally recognize other aspects of the image, such as the identity of the model himself (here “Paul Newman”). The image analysis engine 518 can provide image information regarding at least these four objects: the jacket; the pants; the shoes; and the model himself. Upon receiving this information, the query expansion component 526 can first pick out only the part of the image information that pertains to the user's focus-of-interest. More specifically, based on the fact that the user's originally-specified input text includes the word “jacket,” the query expansion component 526 can retain only the label provided by the image analysis engine 518 that pertains to the model's jacket (“XYZ Jacket”). It then respaces the term “this jacket” in the original input text with “XYZ Jacket,” to produce a reformulated text query.

The above examples in FIGS. 8-12 all use the text-based retrieval path, in which the query expansion component 526 uses the image information (provided by the image analysis engine 518) to generate a reformulated text query. FIG. 13 shows an example in which the computing system 502 relies on the image-based retrieval path. Here, the user submits a picture of a jacket while uttering the phrase “Show me jackets like this, but in green.” The text analysis engine 516 determines that the user submits this plural-mode query with the intent of finding similar jackets to the jacket shown in the input image, but with attributes specified in the input text. In response, the image-based retrieval engine 522 performs a search based on both the attribute “green” and a latent semantic vector associated with the input image. It returns a set of candidate images showing green jackets having a style that resembles the jacket in the input image.

In yet other examples, the computing system 502 can invoke both the text-based retrieval path and the image-based retrieval path. In that case, the query results may include a mix of result snippets associated with websites and candidate images.

As a general principle, the computing system 502 can intermesh text analysis and image analysis in different ways based on plural factors, including the environment-specific configuration of the computing system 502, the nature of the input information, etc. The examples set forth in FIGS. 8-13 should therefore be interpreted in the spirit of illustration, not limitation; they do not exhaustively describe the different ways of interweaving text and image analysis.

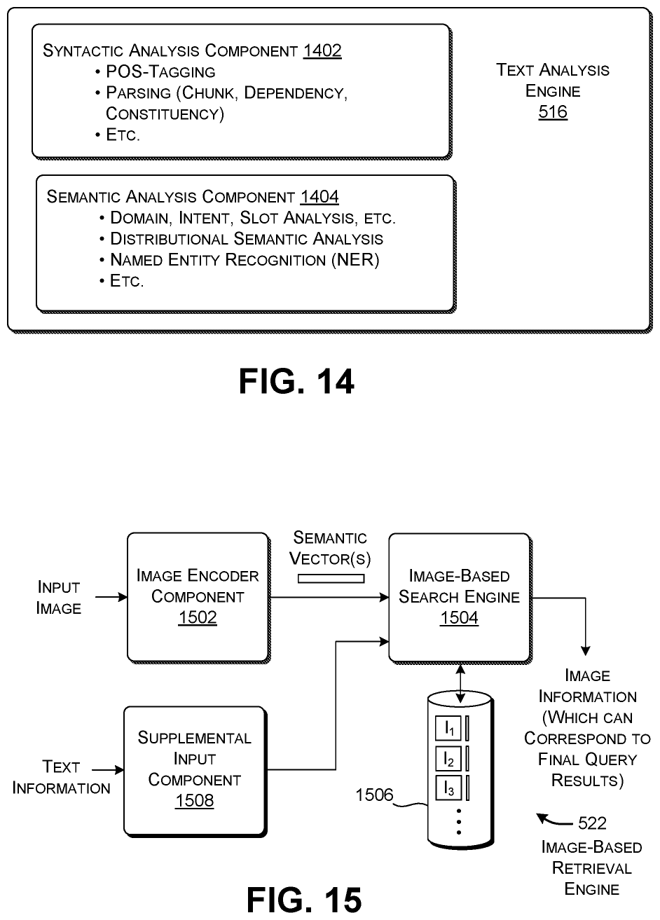

FIG. 14 shows one implementation of the text analysis engine 516. The text analysis engine 516 incudes a syntax analysis component 1402 for analyzing the syntactical structure of the input text, and a semantic analysis component 1404 for analyzing the meaning of the input text. Without limitation, the syntax analysis component 1402 can include subcomponents for performing stemming, part-of-speech tagging, parsing (chunk, dependency, and/or constituency), etc., all of which are well known in and of themselves.

The semantic analysis component 1404 can optionally include a domain determination component, an intent determination component, and a slot value determination component. The domain determination component determines the most probable domain associated with a user's input query. A domain pertains to the general theme to which an input query pertains, which may correspond to a set of tasks handled by a particular application, or a subset of those tasks. For example, the input command “find Mission Impossible” pertains to a media search domain. The intent determination component determines an intent associated with a user's input query. An intent corresponds to an objective that a user likely wishes to accomplish by submitting an input message. For example, a user who submits the command “buy Mission Impossible” intends to purchase the movie “Mission Impossible.” The slot value determination component determines slot values in the user's input query. The slot values correspond to information items that an application needs to perform a requested task, upon interpretation of the user's input query. For example, the command “find Jack Nicolson movies in the comedy genre” includes a slot value “Jack Nicolson” that identifies an actor having the name of “Jack Nicolson,” and a slot value “comedy,” corresponding to a requested genre of movies.

The above-summarized components can use respective machine-trained components to perform their respective tasks. For example, the domain determination component may apply any machine-trained classification model, such as a deep neural network (DNN) model, a support vector machine (SVM) model, and so on. The intent determination component can likewise use any machine-trained classification model. The slot value determination component can use any machine-trained sequence-labeling model, such as a conditional random fields (CRF) model, an RNN model, etc. Alternatively, or in addition, the above-summarized components can use rules-based engines to perform their respective tasks. For example, the intent determination component can apply a rule that indicates that any input message that matches the template “purchase <x>” refers to an intent to buy a specified article, where that article is identified by the value of variable x.

In addition, or alternatively, the semantic analysis component 1404 can include a text encoder component that maps the input text into a text-based semantic vector. The text encoder component can perform this task using a convolutional neural network (CNN). For example, the CNN can convert the text information into a collection of n-gram vectors, and then map those n-gram vectors into a text-based semantic vector.

The semantic analysis component 1404 can include yet other subcomponents, such as a named entity recognition (NER) component. The NER component identifies the presence of terms in the input text that are associated with objects-of-interest, such as particular people, places, products, etc. The NER component can perform this task using a dictionary lookup technique, a machine-trained model, etc.

FIG. 15 shows one implementation of the image-based retrieval engine 522. The image-based retrieval engine 522 includes an image encoder component 1502 for mapping an input image into one or more query semantic vectors. The image encoder component 1502 can perform this task using an image-based CNN. An image-based search engine 1504 then uses an approximate nearest neighbor (ANN) technique to find candidate semantic vectors stored in an index (in a data store 1506) that are closest to the query semantic vector. The image-based search engine 1504 can assess the distance between two semantic vectors using any distance metric, such as cosine similarity. Finally, the image-based search engine 1504 outputs information extracted from the index pertaining to the matching candidate semantic vectors and the matching candidate images associated therewith. For example, assume that the input image shows a particular plant, and that the image-based search engine 1504 identifies a candidate image that is closest to the input image. The image-based search engine 1504 can output any labels, keywords, etc. associated with this candidate image. In some cases, the label information may at least provide the name of the plant.

An offline index-generating component (not shown) can produce the information stored in the index in the data store 1506. In that process, the index-generating component can use the image encoder component 1502 to compute at least one latent semantic vector for each candidate image. The index-generating component stores these vector(s) in an entry in the index associated with the candidate image. The index-generating component can also store one or more textual attributes pertaining to each candidate image. The index-generating component can extract these attributes from various sources. For instance, the index-generating component can extract label information from a caption that accompanies the candidate image (e.g., for the case in which the candidate image originates from a website or document that includes both an image and its caption). In addition, or alternatively, the index-generating component can use the image classification component 520 to classify objects in the image, from which additional label information can be obtained.

As noted above, in some contexts, the image-based retrieval engine 522 serves a support role in a text-based retrieval operation. For instance, the image-based retrieval engine 522 provides image information that allows the query expansion component 526 to reformulate the user's input text. In another context, the image-based retrieval engine 522 serves the primary role in an image-based retrieval operation. In that case, the candidate images identified by the image-based retrieval engine 522 correspond to the query results themselves.

A supplemental input component 1508 serves a role that is particularly useful in the image-based retrieval path. This component 1508 receives text information from the text analysis engine 516 and (optionally) image information from the image classification component 520. It maps this input information into attribute information. The image-based search engine 1504 uses the attribute information in conjunction with the latent semantic vector(s) provided by the image encoder component 1502 to find the candidate images. For example, consider the example of FIG. 13. The supplemental input component 1508 determines that the user's input text specifies the attribute “green.” In response, the image-based search engine 1504 finds a set of candidate images that: (1) have candidate semantic vectors near the query semantic vector in a low-dimension semantic vector space; and (2) have metadata associated therewith that includes the attribute “green.”

The supplemental input component 1508 can map text information to attribute information using any techniques. In one case, the supplemental input component 1508 uses a set of rules to perform this task, which can be implemented as a lookup table. For example, the supplemental input component 1508 can apply a rule that causes it to extract any color-related word in the input text as an attribute. In another implementation, the supplemental input component 1508 uses a machine-trained model to perform its mapping function, e.g., by using a sequence-to-sequence RNN to map input text information into attribute information.

In other cases, the user's input text can reveal the user's focus of interest within an input image that contains plural objects. For example, the user's input image can show the full body of a model. Assume that the user's input text reads “Show me jackets similar to the one this person is wearing.” In this case, the supplemental input component 1508 can provide attribute information that includes the word “jacket.” The image-based search component 1504 can leverage this attribute information to eliminate or demote any candidate image that is not tagged with the word “jacket” in the index. This will operate to exclude images that show only pants, shoes, etc.

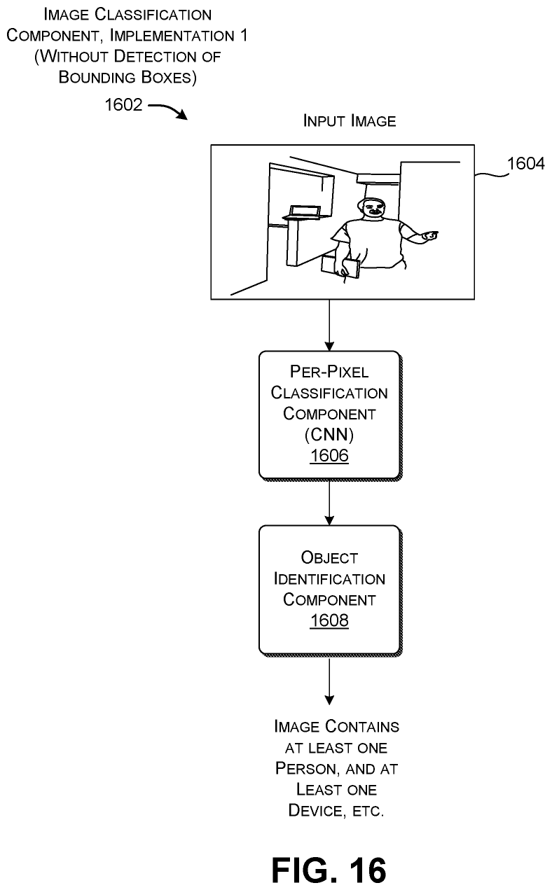

FIGS. 16-18 show three respective implementations of the image classification component 520. Starting with FIG. 16, this figure shows an image classification component 1602 that recognizes objects in an input image, but without also identifying the locations of those objects. For example, the image classification component can identify that an input image 1604 contains at least one person and at least one computing device, but does not also providing bounding box information that identifies the locations of these objects in the image. In one implementation, the image classification component 1602 includes a per-pixel classification component 1606 that identifies the object that each pixel most likely belongs to, with respect to a set of possible object types (e.g., a dog, cat, person, etc.). The per-pixel classification component can perform this task using a CNN. An object identification component 1608 uses the output results of the per-pixel classification component 1606 to determine whether the image contains at least one instance of each object under consideration. The object identification component 1608 can make this determination by generating a normalized score that identifies how frequently pixels associated with each object under consideration appear in the input image. General background information regarding one type of pixel-based object detector may be found in Fang, et al, “From Captions to Visual Concepts and Back,” arXiv:1411.4952v3 [cs.CV], Apr. 14, 2015, 10 pages.

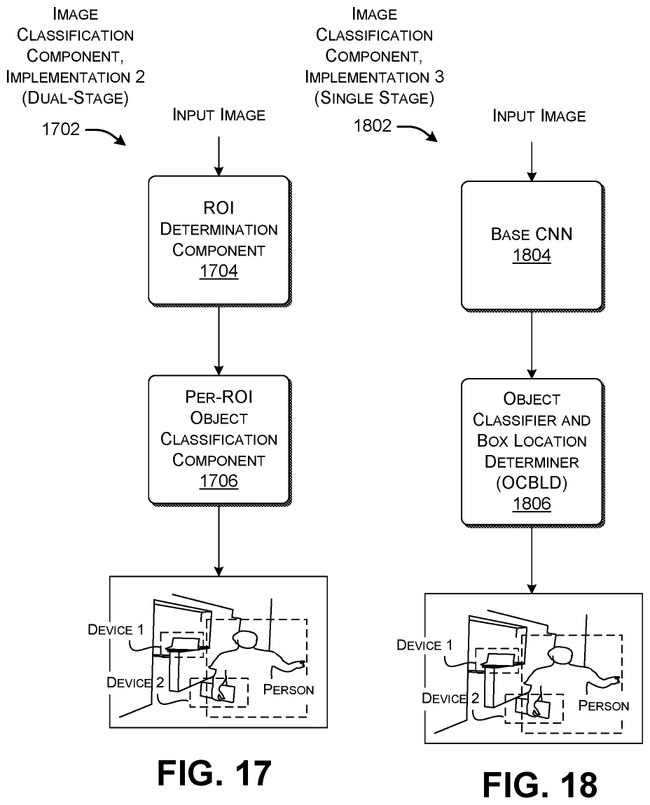

Advancing to FIG. 17, this figure shows a second image classification component 1702 that uses a dual-stage approach to determining the presence and locations of objects in the input image. In the first stage, a ROI determination component 1704 identifies regions-of-interest (ROIs) associated with respective objects in the input image. The ROI determination component 1704 can rely on different techniques to perform this function. In a selective search approach, the ROI determination component 1704 iteratively merges image regions in the input image that meet a prescribed similarity test, initially starting with relatively small image regions. The ROI determination component 1704 can assess similarity based on any combination of features associated with the input image (such as color, brightness, hue, texture, etc.). Upon the termination of this iterative process, the ROI determination component 1704 draws bounding boxes around the identified regions. In another approach, the ROI determination component 1704 can use a Region Proposal Network (RPN) to generate the ROIs. In a next stage, a per-ROI object classification component 1706 uses a CNN or other machine-trained model to identify the mostly likely object associated with each ROI. General background information regarding one illustrative type of dual-stage image classification component may be found in Ren, et al., “Faster R-CNN: Towards Real-Time Object Detection with Region Proposal Networks,” arXiv:1506.01497v3 [cs.CV], Jan. 6, 2016, 14 pages.

FIG. 18 shows a third image classification component 1802 that uses a single stage to determine the presence and locations of objects in the input image. First, this image classification component 1802 uses a base CNN 1804 to convert the input image into an intermediate feature representation (“feature representation”). It then uses an object classifier and box location determiner (OCBLD) 1806 to simultaneously classify objects and determine their respective locations in the feature representation. The OCBLD 1806 performs this task by processing plural version of the feature representation having different respective scales. By performing analysis on versions of different sizes, the OCBLD 1806 can detect objects having different sizes. More specifically, for each version of the representation, the OCBLD 1806 moves a small filter across the representation. At each position of the filter, the OCBLD 1806 considers a set candidate bounding boxes in which an object may or may not be present. For each such candidate bounding box, the OCBLD 1806 generates a plurality of scores, each score representing the likelihood that a particular kind of object is present in the candidate bounding box under consideration. A final-stage suppression component uses non-maximum suppression to identify the most likely objects contained in the image along with their respective bounding boxes. General background information regarding one illustrative type of single-stage image classification component may be found in Liu, et al., “SSD: Single Shot MultiBox Detector,” arXiv:1512.02325v5 [cs.CV], Dec. 29, 2016, 17 pages.

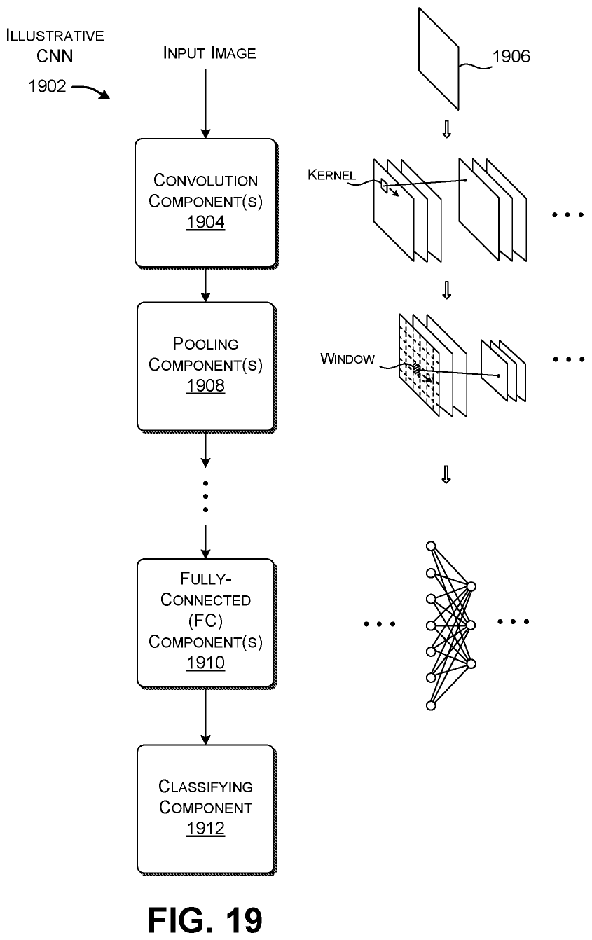

FIG. 19 shows a convolutional neural network (CNN) 1802 that can be used to implement various components of the computing system 502. For example, the kind of architecture shown in FIG. 19 can be used to the implement one or more parts of the image analysis engine 518. The CNN 1902 performs analysis in a pipeline of stages. One of more convolution components 1904 perform a convolution operation on an input image 1906. One or more pooling components 1908 perform a down-sampling operation. One or more fully-connected components 1810 respectively provide one or more fully-connected neural networks, each including any number of layers. More specifically, the CNN 1902 can intersperse the above three kinds of components in any order. For example, the CNN 1902 can include two or more convolution components interleaved with pooling components. In some implementations, the CNN 1802 can include a classification component 1912 that outputs a classification result based on feature information provided by a preceding layer. For example, the classification component 1912 can correspond to a Softmax component, a support vector machine (SVM) component, etc.

In each convolution operation, a convolution component moves an n×m kernel (also known as a filter) across an input image (where “input image” in this general context refers to whatever image is fed to the convolutional component). In one implementation, at each position of the kernel, the convolution component generates the dot product of the kernel values with the underlying pixel values of the image. The convolution component stores that dot product as an output value in an output image at a position corresponding to the current location of the kernel. More specifically, the convolution component can perform the above-described operation for a set of different kernels having different machine-learned kernel values. Each kernel corresponds to a different pattern. In early layers of processing, a convolutional component may apply kernels that serve to identify relatively primitive patterns (such as edges, corners, etc.) in the image. In later layers, a convolutional component may apply kernels that find more complex shapes.

In each pooling operation, a pooling component moves a window of predetermined size across an input image (where the input image corresponds to whatever image is fed to the pooling component). The pooling component then performs some aggregating/summarizing operation with respect to the values of the input image enclosed by the window, such as by identifying and storing the maximum value in the window, generating and storing the average of the values in the window, etc.

A fully-connected component can begin its operation by forming a single input vector. It can perform this task by concatenating the rows or columns of the input image (or images) that are fed to it, to form a single input vector. The fully-connected component then feeds the input vector into a first layer of a fully-connected neural network. Generally, each layer j of neurons in the neural network produces output values zⱼ given by the formula zⱼ=ƒ(Wⱼzⱼ₋₁+bⱼ), for j=2, . . . N. The symbol j−1 refers to a preceding layer of the neural network. The symbol Wⱼ denotes a machine-learned weighting matrix for the layer j, and the symbol bⱼ refers to a machine-learned bias vector for the layer j. The activation function ƒ(⋅) can be formulated in different ways, such as a rectified linear unit (ReLU).

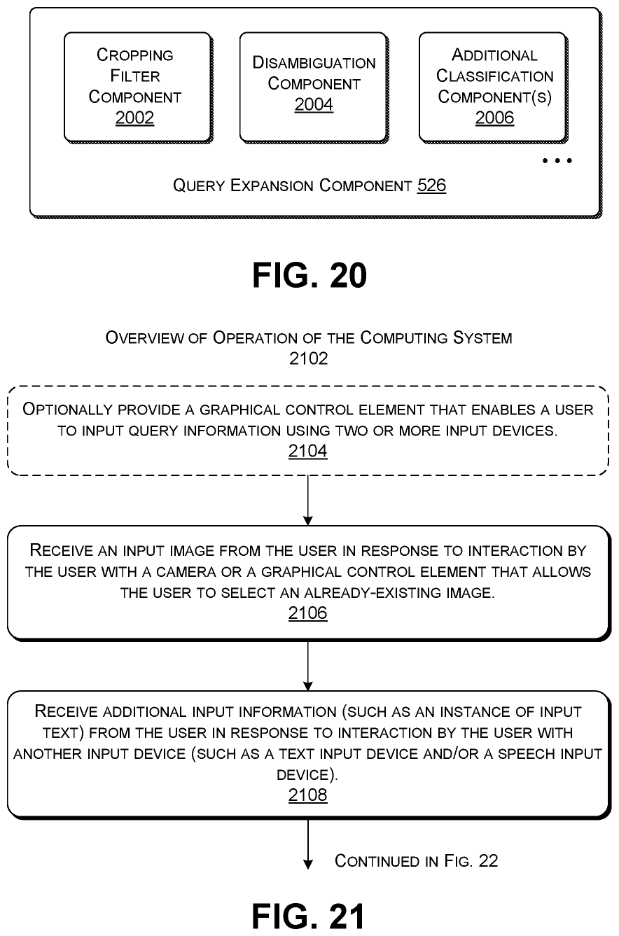

FIG. 20 shows one implementation of the query expansion component 526, which serves a role in the text-based retrieval path. That is, the query expansion component 526 generally operates by supplementing the text information with information obtained from the analysis performed by the image analysis engine 518. It includes a collection of subcomponent that serve that general purpose.

First, a cropping filter component 2002 (“filter component”) operates in those circumstances in which the user's input text is directed to a specific part of an image, rather than the image as a whole. For example, assume that the user provides the input text “What is this?” Here, it is apparent that the user is interested in the principal object captured by an accompanying image. In another case, assume that the user provides the input text “Where can I buy that jacket he is wearing?” or “Who is that person standing farthest to the left?” The filter component 2002 operates in this case by using the input text to select a particular part of the image information (provided by the image analysis engine 518) that is relevant to the user's current focus of interest, while optionally ignoring the remainder of the image information. For example, upon concluding that the user is interested in a particular person in an image that contains plural people, the filter component 2002 can select the labels, keywords, etc. associated with this person, and ignore the textual information regarding other people in the image.

The filter component 2002 can operate by applying context-specific rules. One such rule determines whether any term in the input text is co-referent with any term in the image information. For example, assume that the user's input text reads “What kind of tree is that?”, while the image shows plural objects, such as a tree, a person, and a dog. Further assume that the image analysis engine 2002 recognizes the tree and provides the label “elm tree” in response thereto, along with labels associated with other objects in the image. The filter component 2002 can determine that the word “tree” in the input text matches the word “tree” in the image information. In response to this insight, the filter component 2002 can retain the part of the image information that pertains to the tree, while optionally discarding the remainder that is not relevant to the user's input text.

Another rule determines whether: (1) the image analysis engine 518 identifies plural objects; and (2) the input text includes positional information indicative of the user's interest in part of the input image. If so, then the filter component 2002 can use the positional information to retain the appropriate part of the image information, while discarding the remainder. For example, assume that the input image shows two men standing side-by-side. And assume that the user's input text reads “Who is the man on the left?” In response, the filter component 2002 can select object information pertaining to the person who is depicted on the left side of the image.

Still more complex rules can be used that combine aspects of the above two kinds of rules. For example, the user's text may read “Who is standing to the left of the woman with red hair?” The filter component 2002 can first consult the image information to identify the object corresponding to a woman with red hair. The filter component 2002 can then consult the image information to find the object that is positioned to the left of the woman having red hair.

A disambiguation component 2004 modifies the text information based on the image information to reduce ambiguity in the text information. As one part of its analysis, the disambiguation component 2002 performs co-reference resolution. It does so by identifying an ambiguous term in the input text, such as a pronoun (e.g., “he,” “she,” “their,” “this,” “it,” “that,” etc.). It then replaces or supplements the ambiguous term with textual information extracted from the image information. For example, per the example of FIG. 8, the input text reads “Where can I buy this on sale.” The term “this” is an ambiguous term. The disambiguation component replaces the word “this” with the term “Jerry's soda” identified by the image analysis engine 518.

The disambiguation component 2004 can operate based on a set of context-specific rules. According to one rule, the disambiguation component 2004 replaces an ambiguous term in the input text with a gender-appropriate entity name specified in the image information. In another implementation, the disambiguation component 2004 can use a machine-trained model to determine the best match between an ambiguous term in the input text and plural entity names specified in the image information. A training system can train this model based on a corpus of training examples. Each positive training example pairs an ambiguous term in an instance of input text with an appropriate label associated with an object in an image.

The query expansion components 526 can also include one or more additional classification components 2006. Each classification component can receive text information from the text analysis engine 516 and image information from the image analysis engine 518. It can then generate some classification result that depends on insight extracted from the input text and input image. For example, one such classification model can classify the intent of the user's plural-mode query based on both the text information and the image information.

While the query expansion component 526 plays a role in the text-based retrieval path, the supplemental input component 1508 (of FIG. 15) can apply similar techniques in generating attribute information, which it then feeds to the image-based search engine 1504. For example, the supplemental input component 1508 can use label information that it obtains from the image classification component 520 to disambiguate the user's input text. The image-based search engine 1504 can then use the disambiguated input text in conjunction with the latent semantic vector(s) (associated with the input image) to retrieve appropriate candidate images.

B. Illustrative Processes

FIGS. 21-24 show processes that explain the operation of the computing system 502 of Section A in flowchart form. Since the principles underlying the operation of the computing system 502 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

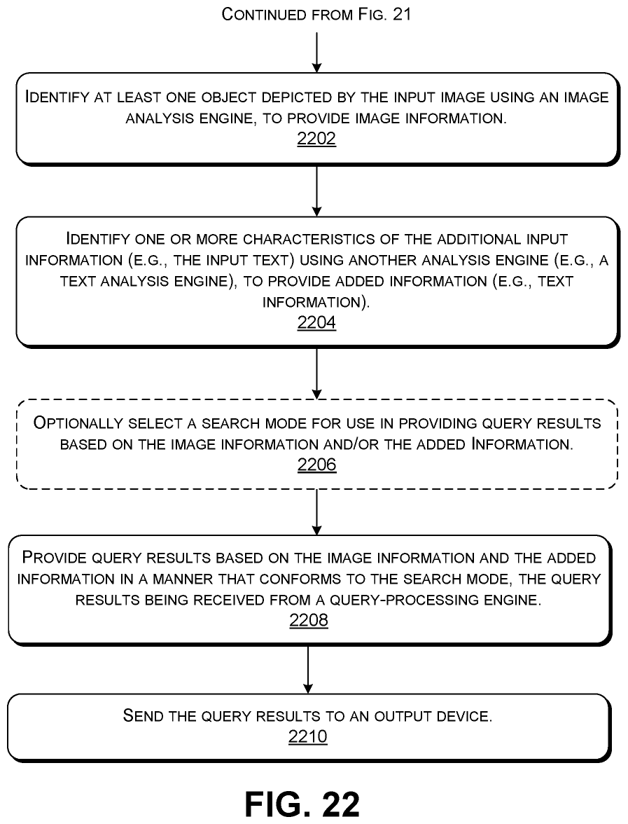

FIGS. 21 and 22 together show a process 2102 that represents an overview of one manner of operation of the computing system 502. In block 2104 of FIG. 21, the computing system 502 provides a user interface presentation 204 that enables the user to input query information using two or more input devices. In block 2106, the computing system 502 receives an input image from the user in response to interaction by the user with a camera 512 or a graphical control element 214 that allows the user to select an already-existing image. In block 2108, the computing system 502 receives additional input information (such as an instance of input text) from a user in response to interaction by the user with another input device (such as a text input device 510 and/or a speech input device 508).

In block 2202 of FIG. 22, the computing system 502 identifies at least one object depicted by the input image using an image analysis engine 518, to provide image information. In block 2204, the computing system 502 identifies one or more characteristics of the additional input information (e.g., the input text) using another analysis engine (e.g., a text analysis engine 516), to provide added information (e.g., text information). In block 2206, the computing system 502 selects a search mode for use in providing query results based on the image information and the added information (e.g., the text information). In block 2208, the computing system 502 uses a query-processing engine 504 to provide query results based on the image information and the added information in a manner that conforms to the search mode determined in block 2206. In block 2210, the computing system 502 sends the query results to an output device.

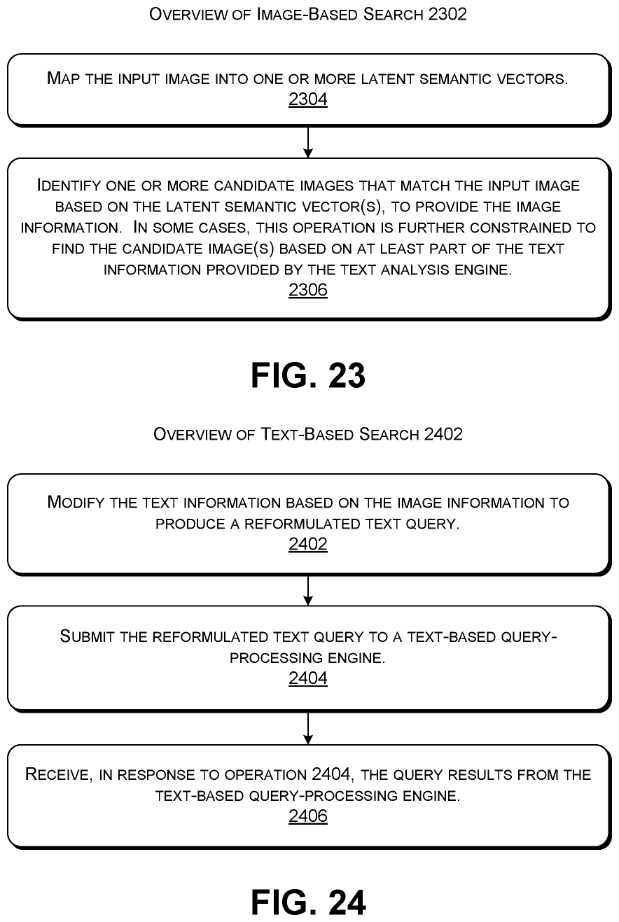

FIG. 23 shows a process 2302 that summarizes an image-based retrieval operation performed by the computing system 502 of FIG. 5. In block 2304, the computing system 502 maps an input image into one or more latent semantic vectors. In block 2306, the computing system 502 uses the latent sematic vector(s) to identify one or more candidate images that match the input image, to provide the image information. In some scenarios, the matching operation of block 2304 is further constrained to find matching candidate image(s) based on at least part of the text information provided by the text analysis engine 516.

FIG. 24 shows a process 2402 that summarizes a text-based retrieval operation performed by the computing system 502 of FIG. 5. In block 2404, the computing system 502 modifies the text information (provided by the text analysis engine 516) based on the image information (provided by the image analysis engine 518) to produce a reformulated text query. In block 2406, the computing system 502 submits the reformulated text query to a text-based query-processing engine 504. In block 2406, the computing system 502 receives, in response to the submitting operation, the query results from the text-based query-processing engine 504.

C. Representative Computing Functionality

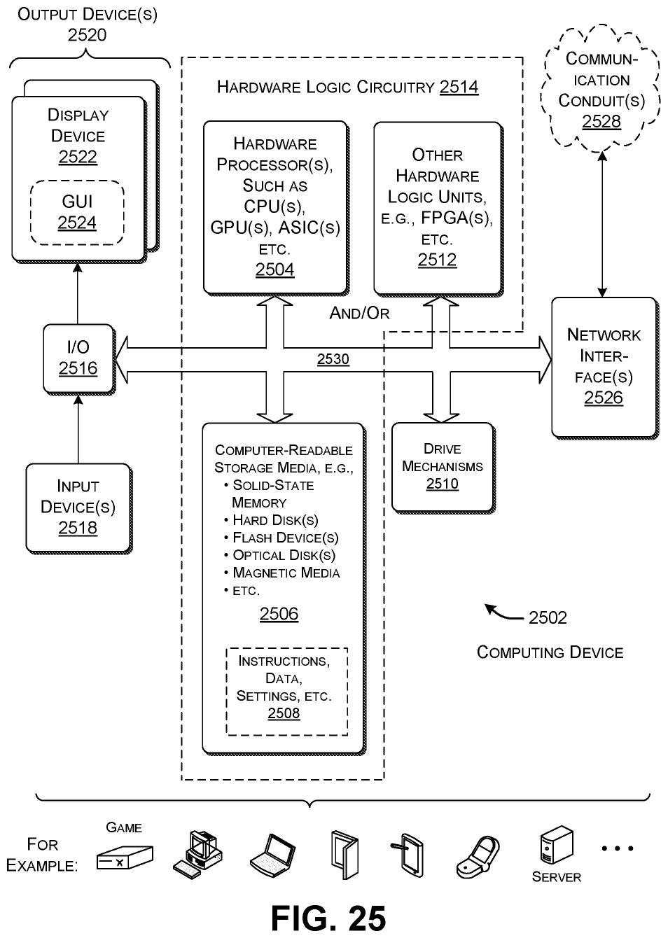

FIG. 25 shows a computing device 2502 that can be used to implement any aspect of the mechanisms set forth in the above-described figures. For instance, the type of computing device 2502 shown in FIG. 25 can be used to implement any server or user computing device shown in 7. In all cases, the computing device 2502 represents a physical and tangible processing mechanism.

The computing device 2502 can include one or more hardware processors 2504. The hardware processor(s) can include, without limitation, one or more Central Processing Units (CPUs), and/or one or more Graphics Processing Units (GPUs), and/or one or more Application Specific Integrated Circuits (ASICs), etc. More generally, any hardware processor can correspond to a general-purpose processing unit or an application-specific processor unit.

The computing device 2502 can also include computer-readable storage media 2506, corresponding to one or more computer-readable media hardware units. The computer-readable storage media 2506 retains any kind of information 2508, such as machine-readable instructions, settings, data, etc. Without limitation, for instance, the computer-readable storage media 2506 may include one or more solid-state devices, one or more magnetic hard disks, one or more optical disks, magnetic tape, and so on. Any instance of the computer-readable storage media 2506 can use any technology for storing and retrieving information. Further, any instance of the computer-readable storage media 2506 may represent a fixed or removable unit of the computing device 2502. Further, any instance of the computer-readable storage media 2506 may provide volatile or non-volatile retention of information.

The computing device 2502 can utilize any instance of the computer-readable storage media 2506 in different ways. For example, any instance of the computer-readable storage media 2506 may represent a hardware memory unit (such as Random Access Memory (RAM)) for storing transient information during execution of a program by the computing device 2502, and/or a hardware storage unit (such as a hard disk) for retaining/archiving information on a more permanent basis. In the latter case, the computing device 2502 also includes one or more drive mechanisms 2510 (such as a hard drive mechanism) for storing and retrieving information from an instance of the computer-readable storage media 2506.

The computing device 2502 may perform any of the functions described above when the hardware processor(s) 2504 carry out computer-readable instructions stored in any instance of the computer-readable storage media 2506. For instance, the computing device 2502 may carry out computer-readable instructions to perform each block of the processes described in Section B.

Alternatively, or in addition, the computing device 2502 may rely on one or more other hardware logic units 2512 to perform operations using a task-specific collection of logic gates. For instance, the hardware logic unit(s) 2512 may include a fixed configuration of hardware logic gates, e.g., that are created and set at the time of manufacture, and thereafter unalterable. Alternatively, or in addition, the other hardware logic unit(s) 2512 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 25 generally indicates that hardware logic circuitry 2514 includes any combination of the hardware processor(s) 2504, the computer-readable storage media 2506, and/or the other hardware logic unit(s) 2512. That is, the computing device 2502 can employ any combination of the hardware processor(s) 2504 that execute machine-readable instructions provided in the computer-readable storage media 2506, and/or one or more other hardware logic unit(s) 2512 that perform operations using a fixed and/or programmable collection of hardware logic gates. More generally stated, the hardware logic circuitry 2514 corresponds to one or more hardware logic units of any type(s) that perform operations based on logic stored in and/or otherwise embodied in the hardware logic unit(s).

In some cases (e.g., in the case in which the computing device 2502 represents a user computing device), the computing device 2502 also includes an input/output interface 2516 for receiving various inputs (via input devices 2518), and for providing various outputs (via output devices 2520). Illustrative input devices include a keyboard device, a mouse input device, a touchscreen input device, a digitizing pad, one or more static image cameras, one or more video cameras, one or more depth camera systems, one or more microphones, a speech recognition mechanism, any movement detection mechanisms (e.g., accelerometers, gyroscopes, etc.), and so on. One particular output mechanism may include a display device 2522 and an associated graphical user interface presentation (GUI) 2524. The display device 2522 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing device 2502 can also include one or more network interfaces 2526 for exchanging data with other devices via one or more communication conduits 2528. One or more communication buses 2530 communicatively couple the above-described units together.

The communication conduit(s) 2528 can be implemented in any manner, e.g., by a local area computer network, a wide area computer network (e.g., the Internet), point-to-point connections, etc., or any combination thereof. The communication conduit(s) 2528 can include any combination of hardwired links, wireless links, routers, gateway functionality, name servers, etc., governed by any protocol or combination of protocols.

FIG. 25 shows the computing device 2502 as being composed of a discrete collection of separate units. In some cases, the collection of units may correspond to discrete hardware units provided in a computing device chassis having any form factor. FIG. 25 shows illustrative form factors in its bottom portion. In other cases, the computing device 2502 can include a hardware logic unit that integrates the functions of two or more of the units shown in FIG. 1. For instance, the computing device 2502 can include a system on a chip (SoC or SOC), corresponding to an integrated circuit that combines the functions of two or more of the units shown in FIG. 25.

The following summary provides a non-exhaustive set of illustrative aspects of the technology set forth herein.

According to a first aspect, one or more computing devices for providing query results are described. The computing device(s) include hardware logic circuitry, itself including: (a) one or more hardware processors that perform operations by executing machine-readable instructions stored in a memory, and/or (b) one or more other hardware logic units that perform operations using a task-specific collection of logic gates. The operations include: receiving an input image from a user in response to interaction by the user with a camera or a graphical control element that allows the user to select an already-existing image; receiving an instance of input text from the user in response to interaction by the user with a text input device and/or a speech input device; identifying at least one object depicted by the input image using an image analysis engine, to provide image information, the image analysis engine being implemented by the hardware logic circuitry; identifying one or more characteristics of the input text using a text analysis engine, to provide text information, the text analysis engine being implemented by the hardware logic circuitry; providing query results based on the image information and the text information; and sending the query results to an output device.

According to a second aspect, the operation of receiving the input image and the operation of receiving the input text occur within a single turn of a query session.

According to a third aspect, relating to the second aspect, the operation of receiving the input image and the operation of receiving the input text occur in response to interaction by the user with a user interface presentation that enables the user to provide the input image and the input text in the single turn.

According to a fourth aspect, the operation of receiving the input image occurs in a first turn of a query session and the operation of receiving the input text occurs in a second turn of the query session, the first turn occurring prior to or after the second turn.

According to a fifth aspect, the query results are provided by a question-answering engine. The operations further include: determining that a dialogue state of a dialogue has been reached in which a search intent of a user remains unsatisfied after one or more query submissions; and prompting the user to submit another input image in response to the operation of determining.

According to a sixth aspect, the operation of identifying one or more characteristics of the input text includes identifying an intent of the user in submitting the text.

According to a seventh aspect, the operation of identifying at least one object in the input image includes using a machine-trained classification model to identify the at least one object.

According to an eighth aspect, relating to the seventh aspect, the operations further include selecting the at least one machine-trained classification model based on the text information provided by the text analysis engine.

According to a ninth aspect, the operation of identifying at least one object includes: mapping the input image into one or more latent semantic vectors; and identifying one or more candidate images that match the input image based on the one or more latent semantic vectors, to provide the image information.

According to a tenth aspect, relating to the ninth aspect, wherein the operation of identifying one or more candidate images is further constrained to find the one or more candidate images based on at least part of the text information provided by the text analysis engine. Here, the query results include the image information itself.

According to an eleventh aspect, the operation of providing includes: modifying the text information based on the image information to produce a reformulated text query; submitting the reformulated text query to a text-based query-processing engine; and receiving, in response to operation of submitting, the query results from the text-based query-processing engine.

According to a twelfth aspect, relating to the eleventh aspect, the operation of modifying includes replacing a first term in the input text with a second term included in the image information, or appending the second term to the input text.

According to a thirteenth aspect, relating to the twelfth aspect, the operations further include using the input text to filter the image information, to select the second term that is used to modify the input text.

According to a fourteenth aspect, the operations further include: selecting a search mode for use in providing the query results based on the image information and/or the text information. The operation of providing provides the query results in a manner that conforms to the search mode.

According to a fifteenth aspect, a computer-implemented method is described for providing query results. The method includes: providing a user interface presentation that enables a user to input query information using two or more input devices; receiving an input image from the user in response to interaction by the user the user interface presentation; receiving an instance of input text from the user in response to interaction by the user with the user interface presentation, the operation of receiving the input text occurring in a same turn of a query session as the operation of receiving the input image; identifying at least one object depicted by the input image using an image analysis engine, to provide image information; identifying one or more characteristics of the input text using a text analysis engine, to provide text information; providing query results based on the image information and the text information; and sending the query results to an output device.

According to a sixteenth aspect, relating to the fifteenth aspect, the operation of identifying at least one object includes: mapping the input image into one or more latent semantic vectors; and identifying one or more candidate images that match the input image based on the one or more latent semantic vectors, to provide the image information. The operation of identifying one or more candidate images is further constrained to find the one or more candidate images based on at least part of the text information provided by the text analysis engine. Here, the query results include the image information itself.

According to a seventeenth aspect, relating to the fifteenth aspect, the operation of providing includes: modifying the text information based on the image information to produce a reformulated text query; submitting the reformulated text query to a text-based query-processing engine; and receiving, in response to the operation of submitting, the query results from the text-based query-processing engine.

According to an eighteenth aspect, a computer-readable storage medium for storing computer-readable instructions is described. The computer-readable instructions, when executed by one or more hardware processors, perform a method that includes: receiving an input image from a user in response to interaction by the user with a camera or a graphical control element that allows the user to select an already-existing image; receiving additional input information from the user in response to interaction by the user with another input device, the operation of receiving additional input information using a different mode of expression compared to the operation of receiving an input image; identifying at least one object depicted by the input image using an image analysis engine, to provide image information; identifying one or more characteristics of the additional input information using another analysis engine, to provide added information; selecting a search mode for use in providing query results based on the image information and/or the added information; providing the query results based on the image information and the added information in a manner that conforms to the search mode; and sending the query results to an output device.

According to an nineteenth aspect, relating to the eighteenth aspect, the operation of receiving the input image and the operation of receiving the additional input information occur within a single turn of a query session.

According to a twentieth aspect, relating to the eighteenth aspect, the additional input information is text.

A twenty-first aspect corresponds to any combination (e.g., any logically consistent permutation or subset) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computing devices for providing query results, comprising:
hardware logic circuitry including: (a) one or more hardware processors that perform operations by executing machine-readable instructions stored in a memory, and/or (b) one or more other hardware logic units that perform the operations using a task-specific collection of logic gates, the operations including:
receiving an input image from a user in response to interaction by the user with a camera or a graphical control element that allows the user to select an already-existing image;
receiving an instance of input text from the user in response to interaction by the user with a text input device and/or a speech input device;
identifying at least one object depicted by the input image using an image analysis engine, to provide image information, the image analysis engine being implemented by the hardware logic circuitry;
identifying one or more characteristics of the input text using a text analysis engine, to provide text information, the text analysis engine being implemented by the hardware logic circuitry;
providing query results based on the image information and the text information; and
sending the query results to an output device,
wherein the operations further include selecting at least one machine-trained classification model from plural selectable classification models based on the text information provided by the text analysis engine, wherein said identifying at least one object in the input image includes using said at least one machine-trained classification model that is selected to identify said at least one object.

2. (canceled)

3. The one or more computing devices of claim 1, wherein said receiving the input image and said receiving the input text occur in response to interaction by the user with a user interface presentation that enables the user to provide the input image and the input text via interaction with a same graphical control element.

4. (canceled)

5. The one or more computing devices of claim 1, wherein the query results are provided by a question-answering engine, and wherein the operations further comprise:
determining that a dialogue state of a dialogue has been reached in which a search intent of a user remains unsatisfied after one or more query submissions; and
prompting the user to submit another input image in response to said determining.

6. The one or more computing devices of claim 1, wherein said identifying said one or more characteristics of the input text includes identifying an intent of the user in submitting the text.

7-10. (canceled)

11. The one or more computing devices of claim 1, wherein said providing includes:
modifying the text information based on the image information to produce a reformulated text query;
submitting the reformulated text query to a text-based query-processing engine; and
receiving, in response to said submitting, the query results from the text-based query-processing engine.

12. (canceled)

13. (canceled)

14. The one or more computing devices of claim 1, wherein the operations further include:
selecting a search mode for use in providing the query results based on the image information and/or the text information,
wherein said providing provides the query results in a manner that conforms to the search mode.

15. A computer-implemented method for providing query results, comprising:
providing a user interface presentation that enables a user to input query information using two or more input devices;
receiving an input image from the user in response to interaction by the user with a graphical control element provided by the user interface presentation;
receiving an instance of input text from the user in response to interaction by the user with the same graphical control element of the user interface presentation, said receiving the input text occurring in a same turn of a query session as said receiving the input image;
identifying at least one object depicted by the input image using an image analysis engine, to provide image information;
identifying one or more characteristics of the input text using a text analysis engine, to provide text information;
providing query results based on the image information and the text information; and
sending the query results to an output device.

16. The computer-implemented method of claim 15, wherein said identifying at least one object comprises:
mapping the input image into one or more latent semantic vectors; and
identifying one or more candidate images that match the input image based on said one or more latent semantic vectors, to provide the image information,
wherein said identifying one or more candidate images is further constrained to find said one or more candidate images based on at least part of the text information provided by the text analysis engine, and
wherein the query results include the image information itself.

17. The computer-implemented method of claim 15, wherein said providing includes:
modifying the text information based on the image information to produce a reformulated text query;
submitting the reformulated text query to a text-based query-processing engine; and
receiving, in response to said submitting, the query results from the text-based query-processing engine.

18. A computer-readable storage medium for storing computer-readable instructions, the computer-readable instructions, when executed by one or more hardware processors, performing a method that comprises:
receiving an input image from a user in response to interaction by the user with a camera or a graphical control element that allows the user to select an already-existing image;
receiving input text from the user in response to interaction by the user with another input device, said receiving input text using a different mode of expression compared to said receiving an input image;
mapping the input image into one or more latent semantic vectors;
mapping the input text into textual attribute information; and
identifying one or more candidate images that match the input image and the textual attribute information, each candidate image having a latent semantic vector specified in an index that matches a latent semantic vector produced by said mapping, and having textual metadata specified in the index that matches the textual attribute information,
at least one particular candidate image having particular textual metadata stored in the index that originates from text that accompanies the particular candidate image in a source document from which the particular candidate image is obtained.

19. (canceled)

20. (canceled)

21. The one or more computing devices of claim 1, wherein said identifying of said one or more characteristics of the input text includes determining a kind of question that the user is asking, and wherein said selecting selects at least one machine-trained classification model that has been trained to answer the kind of question that is identified.

22. The one or more computing devices of claim 1, wherein said at least one machine-trained classification model that is selected includes at least two machine-trained classification models.

23. The one or more computing devices of claim 1, wherein the image analysis performed by the image analysis engine is also based on the text information provided by the text analysis engine.

24. The one or more computing devices of claim 1, wherein the input text includes positional information that describes a position of a particular object in the input image that the user is interested in, in relation to at least one other object in the input image, and wherein said providing query results uses the positional information to identify the particular object and provide the query results.

25. The one or more computing devices of claim 1, wherein the operations further include applying optical character recognition to text that appears in the input image to provide textual information, and wherein said providing query results is also based on the textual information.

26. The computer-implemented method of claim 15, wherein the user interacts with the graphical control element by:
engaging the graphical control element to begin recording of audio content from which the input text is obtained; and
disengaging the graphical control element to end recording of the audio content,
wherein said engaging or disengaging provides an instruction to a camera to capture the input image.

27. The computer-readable storage medium of claim 18, wherein said mapping the input text into textual attribute information uses a set of rules to produce the textual attribute information.

28. The computer-readable storage medium of claim 18, wherein said mapping the input text into textual attribute information uses a machine-trained model to produce the textual attribute information.

29. The computer-readable storage medium of claim 18, wherein said mapping the input text into textual attribute information selectively extracts a part of the input text into the attribute information that satisfies an attribute extraction rule.

30. The computer-readable storage medium of claim 18, wherein said mapping the input text into textual attribute information selectively extracts a part of the input text that expresses a focus of interest of the user.
